(19) United States
(12) Patent Application Publication
(10) Pub. No.: US 2005/0185666 A1
(43) Pub. Date: Aug. 25, 2005

(54) Misbehaving detection method for contention-based wireless communications

(76) Inventors: Maxim Raya, Neuchatel (CH); Imad Aad, Lausanne (CH); Jean-Pierre Hubaux, Preverenges (CH)

Correspondence Address: Supervisor, Patent Prosecution Services;PIPER RUDNICK LLP, 1200 Nineteenth Street, N.W., Washington, DC, 20036-2412, US

(21) Appl. No.: 10/782,802

(22) Filed: Feb. 23, 2004

(51) Int. Cl. H04L 12/43

(52) U.S. Cl. 370/461; 370/447

(57) ABSTRACT

The aim of the present invention is to provide a method to detect misbehavior use of the IEEE 802.11 standard without modifying the standard itself. This aim is reached according to a method for detecting misbehavior in a contention based communication network, this method comprising the steps of: recording at least some of invalid frames with their respective station identification issued by the stations accessing an Access Point, recording at least some of valid frames with their respective station identification issued by the stations accessing the Access Point, determining, for each station, a scrambled ratio based on the number of invalid frames and the number of valid frames, detecting a misbehavior station based on a station which has a substantially lower ratio than the other stations.

This invention on concerns the field of wireless communications, in particular the communications under the standard IEEE 802.11

### 1. BACKGROUND ART

The proliferation of hotspots based on IEEE 802.11 wireless LANs brings the promise of seamless Internet access from a large number of public locations. However, as the number of users soars, so does the risk of possible misbehavior; to protect themselves, wireless ISPs already make use of a number of security mechanisms, and require mobile stations to authenticate themselves at the Access Points (APs). However, IEEE 802.11 works properly only if the stations also respect the MAC protocol.

The last few years were marked by the widespread deployment of IEEE 802.11 hotspots that provide public wireless access to the Internet. This trend will continue in the near future, according to the predictions of the research firm Allied Business Intelligence (ABI), which estimates that the revenue from hotspots will increase by up to 121% in the next five years and the number of hotspots will jump from 28,000 now to 160,000 by 2007. The commercial operation of these networks has emphasized a set of problems, such as security and billing, which are typically less important or even absent in corporate networks.

A prominent member of this family of challenges is MAC layer greedy behavior, in which a station deliberately misuses the MAC protocol to gain bandwidth at the expense of other stations. The benefits of this misuse are the following:
It can result in significant bandwidth gains as it directly deals with the wireless medium; therefore it is more efficient than misbehavior at the network and transport layers.
It is hidden and independent from upper layers and hence cannot be detected by any mechanism designed for those layers. Thus, it can be combined with upper layer misbehavior to enhance it.
It is always usable, since all the wireless stations use the same IEEE 802.11 MAC protocol; in contrast, for example, cheating with TCP yields no benefits against UDP competing sources.

In this specification, we explore this space of user misbehavior, rarely and incompletely addressed in the literature. Rather than just presenting specific misbehavior techniques (as it is often the case in previous research), we propose a classification of the different MAC misbehavior techniques and illustrate them with representative examples. Then, we present a solution, i.e. a system for detecting MAC misbehavior in a transparent way to the operation of the network. The key features of the invention are its (1) compatibility with existing networks, (2) applicability to future versions of IEEE 802.11 with minor changes, and (3) seamless integration in the API without interfering with its normal functions (this is achieved by means of a statistical approach based on traffic monitoring).

Based on the output of the detection system, the WISP (Wireless ISP) can decide its reaction to cheating users. For example, the operator can charge a penalty bill, reduce the service quality, or even completely stop the service depending on the extent of the observed cheating and the responsiveness of the cheater.

Kyasanur and Vaidya (publication “Dependable Systems and Networks”, June 2003) have addressed the MAC layer misbehavior using detection and correction mechanisms. The main idea is to let the receiver assign and send backoff values to the sender in CTS and ACK frames and then use them to detect potential misbehavior. The latter is handled using a correction scheme that adds to the next backoff a penalty that is a function of the observed misbehavior. This solution achieves its results, however, at the expense of the following issues:
It requires a modification of the IEEE 802.11 MAC protocol in a way that is incompatible with the current standard. Such an approach is practically unfeasible.
It gives control to the receiver over the sender, by making the former assign backoff values to the latter in both the detection and the correction schemes. Hence the proposed approach opens the door to new misbehavior techniques, including misbehaving receivers and collusion between sender and receiver.
It creates communication and computation overhead. The first is due to the addition of new frame header fields and the second to the detection and correction schemes that have to compute backoffs and in some cases penalties for each individual frame of the sending station (in the infrastructure case, all this load will be centralized at the AP).
It considers only stations with backlogged traffic to detect misbehavior. But if the misbehaving station generates traffic with a large inter-packet delay, the latter may result in the measured backoff being larger than the assigned one and hence leave the cheater undetected.

Analyzing tools for IEEE 802.11 are known from US 2003/0135762. This description mainly addresses the problem of security over unauthorized or threatening stations. Solutions are described to detect, locate and neutralize such devices. The monitoring mechanisms are not intended to stations that are properly registered. Such solutions were developed in response to malicious portable computers that usurp an authorized identity, gather radio transmitted data, and finally can disconnect the service by massively emitting frames. No indications are given against greedy stations that do not follow the protocol.

In the document WO03/025597, a protocol analyzing tool is described which mainly focuses on the content of the frames. Frame headers are analyzed to detect misuse of the protocol. This tool is intended to detect software compatibility and the proper formatting of the frames.

### 2. SUMMARY OF THE INVENTION

The main interest for a cheating station is to increase its share of the common wireless bandwidth. To achieve this, it uses one or more of the techniques presented in the following sections.

According to the method of the invention, monitoring program embedded in the Access Point collects traffic information and runs statistical analysis on this data to detect the cheating stations.

Two categories of misbehavior can be highlighted:

2.1. Downstream Bandwidth (Access Point to the Stations)

A large part of the usage of an Access Point is based on TCP such as Internet browsing and e-mail reading. It is well known that the major activity is directed to the stations, the upstream being essentially TCP request and acknowledgement packets.

The cheating station aims at increasing its own downstream bandwidth by decreasing the rates of the TCP sources sending traffic to the remaining stations through the AP.

The purpose of the invention is to firstly address this problem and secondly propose a solution.

2.2. Upstream Bandwidth (from the Stations to the Access Point)

It is also interesting to investigate the upstream aspect since in some cases, such as FTP transfer or uploading images or data, the temptation to increase the bandwidth to the detriment of the other stations is high.

The purpose of the invention is to firstly address this problem and secondly propose a solution.

The aim of the present invention is to provide a method to detect misbehavior use of the IEEE 802.11 standard without modifying the standard itself.

This aim is achieved by the method according to claim 1 to 11.

### 3. BRIEF DESCRIPTION OF THE DRAWINGS

The invention will be better understood thanks to the attached Figures in which:

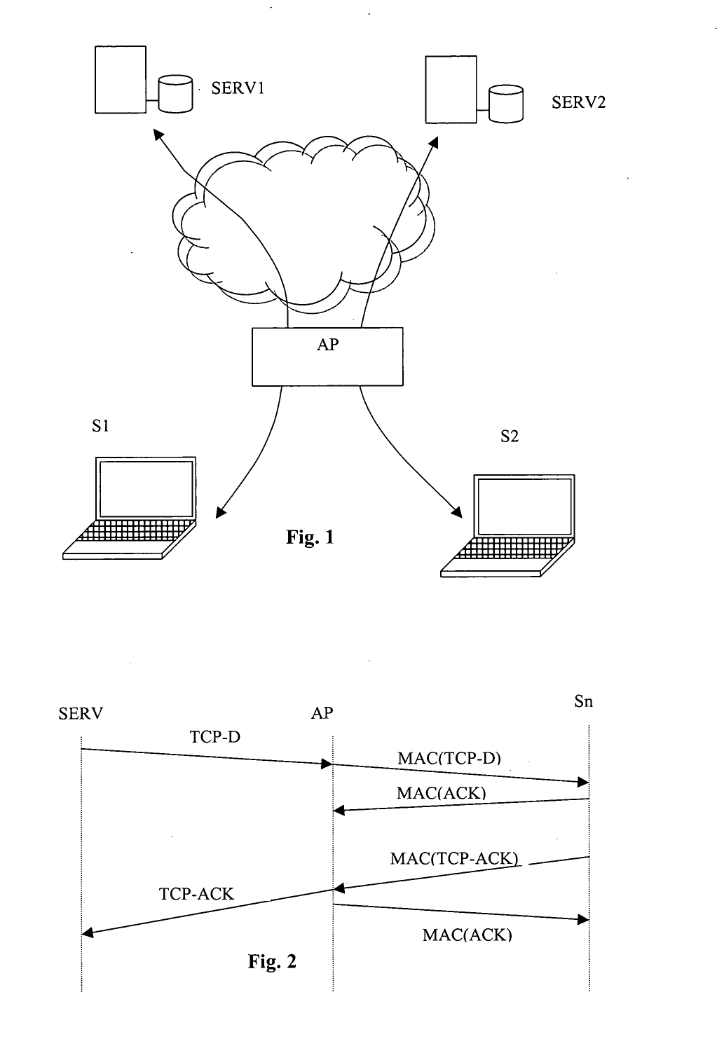

The FIG. 1 illustrates two stations requiring TCP data from two providers,

The FIG. 2 illustrates the transmission exchange between a TCP server and a mobile station via the Access Point,

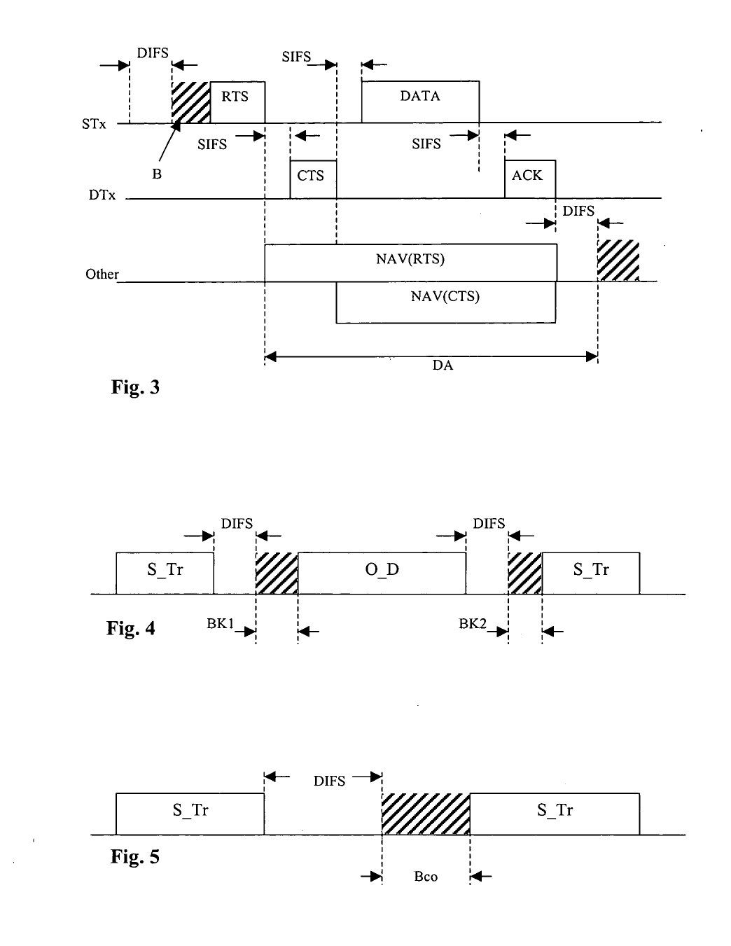

The FIG. 3 illustrates the time diagram of the various exchanges between an access point and a mobile station,

The FIG. 4 illustrates the calculation of the actual backoff time,

The FIG. 5 illustrates the determination of the consecutive backoff.

### 4. DETAILED DESCRIPTION

4.1. Increase of Downstream Bandwidth

The FIG. 1 shows the configuration when a first mobile station S1 attached to the Access Point AP wishes to access a server SERV1 through the Internet. The flow rate based on a TCP protocol is mainly from the server to the station, this latter only sending acknowledgment frames.

At the same time, another mobile station S2 requests the transmission of another server SERV2.

According to this example, the station S2 is a cheater and tries to gather all the available wireless bandwidth of the Access Point AP. This station S2 will scramble some of the frames sent by the station S1 so that the server SERV1 will receive the acknowledgment with some delays or will not receive it at all. As a consequence, this server will reduce the data transmission rate to the station SP1 due to the adaptive nature of the underlying TCP.

The fact that the server SERV1 sends the data packets to the station S1 with a lower rate has the direct consequence that the Access Point receives less data for this station. At the same time, the server SERV2 sends the data packets to the station S2 at the normal (maximum) speed.

Considering the wireless bandwidth, the station S2 will use a large part of it in comparison to the bandwidth used by the station S1.

The method of the invention consists in collecting the valid frames and the rejected frames, i.e. the invalid frames due to the lack of compliance with the check method. Each frame has a checksum value (or CRC, Hash) which represents a validity check of the frame. While receiving a frame, the Access Point AP calculates this validity information and compares the same with the value received from the station. If both validity checks do not match, the frame is rejected. The Access Point does not acknowledge the reception of this frame and the sender will resend it until the Access Point acknowledges it or the maximum number of retransmissions is reached.

As stated above, an invalid frame sent by a given station is at least partially readable, this portion comprising the header of the frame. This header comprises the address of the station which has sent this frame and this claimed method consists in counting the number of scrambled and unscrambled frames per station.

The method of the invention will determine the average scrambled ratio over all stations. When a station has a substantial lower scrambled ratio than the other stations, the probability that this station is the source of the perturbation is high. In the Access Point, a predefined threshold value is set in the initialization parameters which will be used to determine a ratio which is substantially lower than the average value. This threshold value is set according to working conditions of this Access Point.

According to the policy of the Access Point, this station can be disabled and no data packet will be sent to it.

We have described above the attack on a TCP acknowledgment frame from a station to the Access Point. According to another scenario, the cheater station can also scramble the frame sent by the Access Point as illustrated in the FIG. 2.

In this Figure, a server sends a data packet TCP-D to the Access Point AP. This packet is queued and as soon as the wireless layer is ready, the Access Point sends this packet to the destination station Sn. The data packet is encapsulated in a MAC frame MAC(TCP-D).

When the station receives a frame, the first acknowledgment is made on the MAC layer with a suitable MAC acknowledgment MAC-ACK. After processing the data packet, the station sends a TCP acknowledgment which is encapsulated in a MAC layer frame MAC(TCP-ACK). The Access Point AP confirms the reception of this frame with a suitable acknowledgment MAC-ACK. Due to the acknowledgment process of each frame, the Access Point will retransmit this frame until the MAC-ACK is received. The TCP-ACK is transmitted to the server SERV which completes this transaction.

A more sophisticated attack consists in scrambling the downstream traffic and in order to avoid the retransmission by the Access Point, the cheater will send a MAC-ACK on behalf of the destination. Note that MAC-ACK frames have no source field to identify the sender. The consequence will be that the TCP acknowledgment packet will never be sent by the well-behaved station and the transmission rate of the server will be decreased.

A method to detect this behavior is to send frames to non-existing stations (e.g., from the AP). If an acknowledgement is received, the Access Point knows that a cheater is in the transmission area.

To identify the cheating station, the wireless network operator will keep record of the stations that are active when this misbehavior is detected. By tracking the stations that are consistently present when the attack is observed, the operator can identify the cheater after several observations.

4.2. Increase of Upstream Bandwidth

FIG. 3 shows the various exchanges between a source STx and a destination DTx. The IEEE 802.11 WLAN (AP and stations) works in the infrastructure mode using DCF (Distributed Coordination Function), which is the operation mode usually deployed.

With this 4-way handshake mechanism, before a data packet is sent, the station senses the medium. If the medium is idle, for at least a DCF interframe space (DIFS) period of time, a source (either a station or the Access Point) starts its transmission request by sending a RTS (Request To Send) packet to the destination. The destination, after a time called SIFS (Short Inter Frame Space) replies with a CTS (Clear to Send) packet. All stations hearing the RTS and/or the CTS set the NAV (Network Allocation Vector) to the time necessary to complete the packet transmission in order to defer transmission during this time.

In the basic mode, RTS and CTS frames are not used and the same mechanism is applied to DATA/ACK packets only.

As shown in FIG. 3, the DCF delays frame transmissions right after the channel is sensed idle for DIFS time. It waits for an additional random time, backoff time B, after which the frame is transmitted. The backoff time B is bounded by the contention window size CW. This is applied to data frames in the basic scheme, and to RTS frames in the RTS/CTS scheme. The backoff time B of each station is decreased as long as the channel is idle. When the channel is busy, backoff time is freezed. When backoff time reaches zero, the station transmits its frame. If the frame collides with another frame (or RTS), the sender times out waiting for the ACK (or the CTS) and computes a new random backoff time with a larger CW to retransmit the frame with lower collision probability. When a frame is successfully transmitted, the upper backoff time CW is reset to CWmin. The network allocation vector (NAV) of all other stations is set to the frame duration field value in RTS/CTS and DATA headers.

The following are the cheating techniques on upstream bandwidth and their respective detection methods.

4.2.1. Shorter than DIFS

The DIFS delay is a compulsory waiting time after each complete exchange. This completion is indicated with the ACK, showing that a message sent to a recipient was duly received.

According to the standard, each transmitter (the access point AP or any station associated with this AP) must wait a predefined time DIFS before starting a new session.

According to the method of the invention, the statistical analysis of the transaction times allows to detect the user which has not respected this idle period. After having observed this misbehavior repeatedly for several frames from the same station, the Access Point can make a reliable decision.

4.2.2. Oversized NAV

When sending RTS or DATA frames, the cheater can increase the included NAV value in order to prevent the stations in range from sending during this time.

By measuring the actual duration of a transmission (including the DATA, ACK, and optional RTS/CTS) and comparing it with the NAV value set by the station in the RTS or DATA frames, the Access Point can detect stations that regularly set the NAV to very large values.

During the test of this value, a tolerance parameter A (greater than 1) ensures that the Access Point does not mistakenly catch well-behaved stations.

4.2.3. Backoff Manipulation—Maximum Backoff

The backoff time B is a randomly generated time which follows the DIFS time. This time is generated between 0 and CW-1, CW being the upper limit of this time. Depending on the traffic collision, this upper limit is increased so as to lower the collision risk between two stations or the AP. CWmin is the initial value, in case that no collision is detected.

Any station, after a MAC-ACK frame, i.e., the end of a transaction, waits imperatively the DIFS time and starts to wait for an additional time named backoff time B. Each station wishing to communicate with the Access Point, selects randomly this backoff time to reduce the probability that two stations initiate a transmission at the same time.

Since the IEEE 802.11 protocol selects backoffs randomly from the range [0, CW-1] (where CW depends on the number of retransmissions), the maximum selected backoff over a set of frames sent by a given station (without interleaving collisions; otherwise the contention window will be doubled) should be close to CW-1, if the number of samples is large enough.

According to the invention, the maximum backoff test uses this property to suspect stations whose maximum backoff over a set of samples is smaller than a threshold value. Clearly, a tradeoff exists between the number of samples and the threshold; if we increase the threshold (its largest value is CW-1), we have to increase the number of sampled backoffs to get more distinct values and thus avoid false positives. In the frame of the present description, we use a threshold equal to CWmin/2; thus, the test works if the reduced contention window is [0, CWmin/2−1].

Although simple, this test may be easily tricked by a smart cheater that succeeds at making the monitor observe in every sample at least one backoff value larger than or equal to the threshold; channel conditions can also yield a similar result and thus make the test fail. Thus, the maximum backoff test is only auxiliary to the next tests that use statistical averages.

4.2.4. Backoff Manipulation—Actual Backoff

This test consists in measuring the actual backoff as shown in FIG. 4. The main procedure of the test can be summarized as follows:
If between two transmissions from a station S there are no collisions, we assume that S spent all its idle time backing off (although it may be just part of the S interpacket delay). Then we estimate this backoff by computing the sum as illustrated in FIG. 4. The sum is calculated by adding the backoff fractions (e.g., BK1 and BK2). The data transmission O_D in between are transmissions from other stations.
If a collision happens, it will not be possible to know the identities of the senders of the colliding frames and hence the stations whose measured actual backoff should be updated. To avoid complexity, collisions are simply not taken into account and both the current and the next backoffs are not measured for any station.

As illustrated in FIG. 4, transmissions S_Tr from station S are interleaved with one or more transmissions O_D from other nodes (including the Access Point). The transmission includes in addition to the DATA frame all the control frames, such as RTS, CTS, and ACK, as well as the interleaving idle periods of DIFS. The measured value is the sum (BK1 and BK2) of all idle intervals (not including interframe spaces) between two transmissions from S.

The actual backoff can be determined as follows:

```
if Bac[S] < α x Bnom then
    cheat_count[S] = cheat_count[S] +1
    if cheat_count[S] > K then
        S is misbehaving
else if cheat_count[S] > r
    cheat_count[S] = cheat_count[S] − r
```

in which S is a specific station, Bac is the actual backoff time, cheat_count[S] is the counter of cheat detection, Bnom is the nominal backoff value, K the threshold detection value, α is a tolerance factor in ]0, 1], and r is a redemption factor in [0, 1].

This test denotes the average actual backoff of station S. The time value Bnom is the nominal backoff value, which is equal to the average backoff of the AP if it has enough traffic to compute this value, (the inbound traffic is usually larger than the outbound traffic). If the Access Point does not have enough data to derive a nominal backoff value from its own traffic, it uses an analytical upper bound E[Bac] (This value is defined in “DOMINO: A system to detect greedy behavior in IEEE 802.11 hotspots”, M. Raya, J-P. Hubaux, I. Aad, to appear in MobiSys 2004). We do not use the analytical value in the first place since it depends on the number of active stations and is computed assuming backlogged sources.

The α parameter is configurable according to the desired true positive (correct detection) and false positive (wrong detection) percentages (e.g., α=90%). To decrease the number of false positives, a station should be suspected at least K times (i.e., after at least K monitoring periods) before being considered as a cheater. In addition, each time a station does not cheat, its cheat_count is decremented (until it reaches zero) to reward the correct behavior; this adaptivity also reduces the effect of erroneous detection of well-behaved stations. Although K slightly reduces the responsiveness of the system, it should be small enough (e.g., K=3) to prevent temporal but beneficial, i.e., long enough, misbehavior from being detected.

As it collects no data during collisions, the actual backoff test measures backoffs that are selected only from the [0, CWmin−1] range. Due to its mechanism, this test fails to detect the misbehavior case when the cheater has relatively large interpacket delays (e.g., a TCP source using congestion control). In fact, the test measures these delays instead of backoffs since it adds up the idle periods between transmissions from the same source (see FIG. 4). Hence, although the chosen backoffs may be subject to cheating, the monitor will not be able to measure them correctly; the solution to this problem is provided by the consecutive backoff test.

4.2.5. Backoff Manipulation—Consecutive Backoff

Backoff values are taken only between consecutive non-interleaved transmissions from a station S. This is illustrated in FIG. 5.

The consecutive backoff can be determined as follows:

```
if Bco[S] < α′ x Bnomco then
    cheat_count[S] = cheat_count[S] +1
    if cheat_count[S] > K′ then
        S is misbehaving
else if cheat_count[S] > r′
cheat_count[S] = cheat_count[S] − r′
```

in which S is a specific station, Bco is the backoff time, cheat_count[S] is the counter of cheat detection, Bnomco is the average value, K′ the threshold detection value, α′ is a tolerance factor in ]0, 1], and r′ is a redemption factor in [0, 1].

FIG. 5 illustrates this test, which works in the case of sources with relatively large interpacket delays. It addresses mainly the TCP sources, which represent over 91% of traffic in real networks. The actual backoff test for these sources does not yield the correct values (as explained in the previous paragraph), and consequently cannot detect potential cheating. Since the channel is congested (else, cheating would be pointless), the consecutive backoff test takes advantage of frame queuing at the network interface. In fact, packets arriving at the network interface with large interleaving delays will be queued, ready to be transmitted. The source MAC transmits them separated by the random backoff time only (≦CWmin−1). Hence the monitor measures consecutive backoffs between two successive non-interleaved frames (S_Tr) sent by the same source, thus avoiding the weakness of the actual backoff test with large interpacket delays.

As with the previous test, collected values are averaged and compared to a fraction α′ (e.g., α′=90%) of the average consecutive backoff of the Access Point if enough data is available. Otherwise, the measured backoffs are compared to an upper bound E[Bco] to yield detection (¹This value is defined in “DOMINO: A system to detect greedy behavior in IEEE 802.11 hotspots). As in the actual backoff test, a misbehaving station is detected after having been suspected at least K′ times (e.g., K′=3). The cheat_count of each station is incremented or decremented (until it reaches zero) if the station cheats or behaves well, respectively.

The AP may sense the channel busy while a well behaved station, hidden from the active one, senses an idle channel and keeps reducing its backoff. Therefore, the backoff tests (actual and consecutive) may lead to increased false positives. To avoid this misleading information, the operator can identify the cheater after several observations, tracking the stations that are consistently present where the attack is observed.

It is worth noting that in all the above tests, the cheater does not know the detection parameters such as the monitoring period and the thresholds. Thus, it will be hard to adapt to the detection system in order to avoid being caught, especially if we enable the method of the invention to change its parameters periodically to prevent adaptive cheating.

4.2.6. Scrambled Frames

The cheater may selectively scramble frames belonging to other stations in order to increase their contention windows.

In order to gain a significant share of the common wireless bandwidth using CTS, ACK, DATA scrambling, the cheater has to scramble a relatively large percentage of CTS, ACK, or DATA frames sent by the Access Point toward the other stations. As a result, its average number of retransmissions will be less than that of other stations and it can be detected using the method of the invention. The counter num_rtx(S) is the number of retransmissions of station S during one monitoring period; Φ is a tolerance parameter with a value between 0 and 1.

The scrambled frames status can be determined as follows:
if num_rtx(Si)<Φ×E_{j≠}num_rtx(Si) then Si is misbehaving
   in which num_rtx(Si) is the number of retransmission for the station Si, and E_{j≠}num_rtx(Si) the average number of retransmissions per frame of all other stations.

In the case of DATA frames, one might argue that the AP would not be able to distinguish retransmissions because the DATA frames are scrambled. But since the cheater does not scramble the headers of these frames (otherwise it cannot know if the frame is destined to it), a repeated sequence number in the MAC header indicates a retransmitted frame.

The fact that the frames are encrypted is not a problem for any of the above described detection methods. Even if new security protocols are used to transmit a frame from a mobile to the Access Point, the header of the frame is left in clear. All the detection mechanisms described above can be applied on encrypted frames.

As a general rule, the detection values (threshold values, tolerance parameter) are a set of parameters which are initialized depending of the working conditions of the Access Point. For example, in a environment having a lot of obstacles, the detection method should accept an higher rate of scrambled frames without considering a station as cheater. These detections values are adjusted after a testing phase according to the result of the statistical analysis.

1. A method for detecting misbehavior in a contention based communication network, this method comprising the steps of:
recording at least some of invalid frames with their respective station identification issued by the stations accessing an Access Point,
recording at least some of valid frames with their respective station identification issued by the stations accessing the Access Point,
determining, for each station, a scrambled ratio based on the number of invalid frames and the number of valid frames,
detecting a misbehavior station based on a station which has a substantially lower ratio than the other stations.

2. The method of claim 1, wherein the frames are the acknowledgment frames in a TCP/IP protocol.

3. The method of claim 1 or 2, further comprising the steps of:
calculating an average scrambled ratio on the stations currently connected with the Access Point,
setting a suspicious status in reference with a given station when the same has a scrambled ratio which is below of a predefined threshold value.

4. The method of claim 1 or 2, this method further comprising the steps of:
calculating a first average scrambled ratio on all stations currently connected with the Access Point,
eliminating the stations for which the ratio is substantially higher than this first average scrambled ratio,
calculating a second average scrambled ratio on the remaining stations,
setting a suspicious status in reference with a given station when the same has a scrambled ratio which is below of a predefined threshold value.

5. The method according to claim 1, this method comprising the steps of:
analyzing the frames with their respective time stamp and station identification,
selecting a frame corresponding to an acknowledgment of a first station to the Access Point,
calculating a backoff time to a next frame sent by a second station,
comparing this backoff time with a lower limit and setting a suspicious status relative to the second station in case that the backoff time is smaller than the lower limit.

6. The method according to claim 5, wherein the suspicious status is a counter and each positive detection entails the increment of this counter, and in that, when this counter has reached a predefined threshold, the second station is considered as cheater.

7. The method according to claim 5 or 6, wherein it comprises the further steps of:
selecting a frame corresponding to an acknowledgment of the first station,
calculating the backoff time to the next frame of the second station,
successively storing the backoff times of the second station for a given period,
determining the random character of the stored backoff times and considering the second station as cheater in case that the backoff times are not uniformly distributed in a predefined range.

8. The method according to claim 7, wherein it comprises the step of checking the presence of the maximum value of the range in the stored backoff times.

9. The method according to claim 7, wherein it comprises the steps of:
calculating an average backoff time over the stored backoff times for each station,
calculating an Access Point average value of the backoff times of the Access Point,
setting a suspicious status in reference with a given station when the same has an average backoff value smaller than the Access Point average backoff time value.

10. The method according to claims 5 or 6, wherein in case that the transmission of the second station is interleaved, the backoff time is calculated taking into account the sum of a first waiting time following the DIFS time while the interleaved station starts to transmit and a second waiting time while the second station starts to transmit.

11. The method according to claim 1, wherein it comprises the further steps of:
determining the number of retransmissions from the Access Point to each station,
determining the average number of retransmissions over a predefined period of time per station,
setting a suspicious status in reference with a given station when the same has a number of retransmission substantially below the average number of retransmissions.

12. The method according to claim 1, wherein it comprises the further steps of:
determining the actual duration of a transmission for a given station,
comparing this duration with the declared NAV value in the RTS or DATA frames of this station,
setting a suspicious status in reference with this station in case that the actual duration is smaller than the declared value.
